(19) United States
(12) Patent Application Publication
(10) Pub. No.: US 2023/0401597 A1
(43) Pub. Date: Dec. 14, 2023

(54) Incentivized Marketplaces

(71) Applicant: Trireme Insurance LLC, Cedarhurst, NY (US)

(72) Inventors: Gabriel Mayer, Forest Hills, NY (US); Beau Jensen Walker, Irvine, CA (US); Joe Matthew Queen, Rome, GA (US)

(21) Appl. No.: 17/840,361

(22) Filed: Jun. 14, 2022

(51) Int. Cl. G06Q 30/02; G06Q 30/06

(52) U.S. Cl. CPC G06Q 30/0215; G06Q 30/0619; G06Q 30/0273; G06Q 30/0222

(57) ABSTRACT

The inventive subject matter is directed to incentivized insurance marketplaces that implement tokens existing on a blockchain to incentive participation. At least three roles can exist within a marketplace, including sellers, insurance providers, and insurance purchasers. A seller can be one that sells insurance, such as a broker or an insurance provider, while an insurance provider is the entity that actually provides insurance coverage. An insurance purchaser is an individual or entity that buys an insurance policy. Each role involves giving and taking information, as well as facilitating transactions, which can all result in movement of tokens throughout the system. For example, when an insurance purchaser buys a policy from an insurance provider, the purchaser can offset a cost of the policy by spending tokens, which move to the insurance provider. The insurance provider can spend tokens to access data about users in the marketplace, which can then be used to create better tailored insurance policies.

### FIELD OF THE INVENTION

The field of the invention is incentivized marketplaces that implement tokens on a blockchain.

### BACKGROUND

The background description includes information that may be useful in understanding the present invention. It is not an admission that any of the information provided in this application is prior art or relevant to the presently claimed invention, or that any publication specifically or implicitly referenced is prior art.

Insurance marketplaces, as they currently exist, lack in transparency and often the balance of power in an insurance transaction is weighted heavily in favor of the insurance seller. Generally, when someone wants to buy insurance, that person needs to work with an insurance broker that facilitates buying an insurance policy from an insurance carrier. As a result, insurance carriers often do not sell policies directly to those in need of a policy.

Insurance marketplaces do exist and, in general, establishing a marketplace can lower costs through ordinary forces of capitalism. But it is possible for a marketplace to nevertheless fail to deliver lowered costs when, for example, insurance carriers within the marketplace do not feel those capitalistic pressures due to lack of competition.

With the rise of blockchain technology, new types of marketplaces can be created that make use of tokens on a blockchain to improve efficiency of those marketplaces by encouraging participation that can lead to lowered costs and increased competition. For example, no existing insurance marketplace currently incentivizes users to create accounts and search for insurance policies by rewarding those users with tokens that can then be used to reduce the cost of an insurance policy. And when insurance sellers gain access to information collected from those users through incentivized participation, insurance sellers can get a better understanding of the types of insurance policies that users need. In this process, users are able to choose from better tailored insurance policies, which better match their needs, and by creating incentives to list better tailored policies, prices are better fit to those policies because the provider can exclude unnecessary features that would otherwise inflate an insurance premium cost.

It has yet to be appreciated that insurance marketplaces can be incentivized using tokens on a blockchain.

### SUMMARY OF THE INVENTION

The present invention provides apparatuses, systems, and methods directed to incentives insurance marketplaces. In one aspect of the inventive subject matter, a method of creating an incentivized insurance policy marketplace is contemplated, the method comprising the steps of: creating a pool of tokens on a blockchain; hosting an insurance marketplace configured to facilitate transactions between an insurance provider and an insurance purchaser; receiving, by the insurance purchaser via the insurance marketplace, tokens from the token pool at least upon creating a purchaser account with the insurance marketplace; receiving, by the insurance provider, tokens from the token pool at least upon creating a provider account with the insurance marketplace; and spending, by the insurance purchaser, tokens to purchase an insurance policy from the insurance provider via the insurance marketplace, wherein the spent tokens offset a cost of the insurance policy, and wherein at least a portion of the spent tokens are received by the insurance provider.

In some embodiments, the method includes the added step of receiving, by the insurance purchaser, additional tokens for providing information, where the information includes insurance policy requirements for the insurance purchaser. Methods can also include the step of receiving, by the insurance provider, additional tokens for providing information, wherein the information comprises insurance policy parameters of insurance policies listed for sale on the marketplace.

In some embodiments, the method includes the additional step of receiving, by the insurance purchaser via the insurance marketplace, additional tokens upon conducting a search of the marketplace for available insurance policies. Some methods also include the step of receiving, by the token pool, at least a second portion of the spent tokens, and some embodiments can include the step of spending tokens, by the insurance provider, to advertise insurance policies.

In another aspect of the inventive subject matter, a method of creating an incentivized insurance policy marketplace, comprising: creating a pool of tokens on a blockchain; making the pool of tokens available for purchase on a crypto exchange; creating an insurance marketplace configured to facilitate transactions between an insurance provider and an insurance purchaser; sending, to the insurance purchaser, tokens from the token pool at least upon creating a purchaser account with the insurance marketplace; sending, to the insurance provider, tokens from the token pool at least upon creating a provider account with the insurance marketplace; and facilitating transfer of tokens from the insurance purchaser to the insurance provider upon the insurance purchaser buying an insurance policy from the insurance provider via the insurance marketplace, where the tokens offset a cost of the insurance policy, and where at least a portion of the spent tokens are received by the insurance provider.

Some embodiments include the additional step of sending, to the insurance purchaser, additional tokens for providing information, where the information includes insurance policy requirements for the insurance purchaser. In some embodiments, methods also include the step of sending, to the insurance provider, additional tokens for providing information, where the information comprises insurance policy parameters of insurance policies listed for sale on the marketplace.

The insurance purchaser, in some embodiments, can also send to the insurance purchaser additional tokens upon conducting a search of the marketplace for available insurance policies. In some embodiments, the method additionally includes the step of facilitating transfer, to the token pool, at least a second portion of the spent tokens. Some methods also include the step of advertising insurance policies via the marketplace in exchange for tokens received from the insurance provider.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a flowchart describing token creation.

FIG. 2 is a schematic showing how tokens can be made available from a token pool.

FIG. 3 is a flowchart describing interactions from an insurance purchaser's perspective.

FIG. 4 is a flowchart describing interactions from an insurance seller's perspective.

FIG. 5 is a schematic showing how a marketplace of the inventive subject matter can be organized.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Moreover, and unless the context dictates the contrary, all ranges set forth in this application should be interpreted as being inclusive of their endpoints and open-ended ranges should be interpreted to include only commercially practical values. Similarly, all lists of values should be considered as inclusive of intermediate values unless the context indicates the contrary.

It should be noted that any language directed to a computer should be read to include any suitable combination of computing devices, including servers, interfaces, systems, databases, agents, peers, Engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. The following description includes information that may be useful in understanding the present invention. It is not an admission that any of the information provided in this application is prior art or relevant to the presently claimed invention, or that any publication specifically or implicitly referenced is prior art.

Embodiments of the inventive subject matter are directed to insurance marketplaces that create incentives for participation that can improve the experience of buying and selling insurance. Marketplaces of the inventive subject matter are enhanced through the use of blockchain technology by introducing tokens that can be used in transactions that occur within the marketplace.

Thus, a marketplace of the inventive subject matter needs access to tokens. In some embodiments, existing tokens can be used (e.g., ether, bitcoin, tether, binance coin, to name a few popular tokens), while in some embodiments a new token can be created expressly for use within the marketplace. Advantages of creating a new token include better control over supply and distribution, while advantages of using an established token include more predictable token value and proven technology. For purposes of explanation below, an example using a newly minted token is described, though it should be understood that existing tokens could also be used.

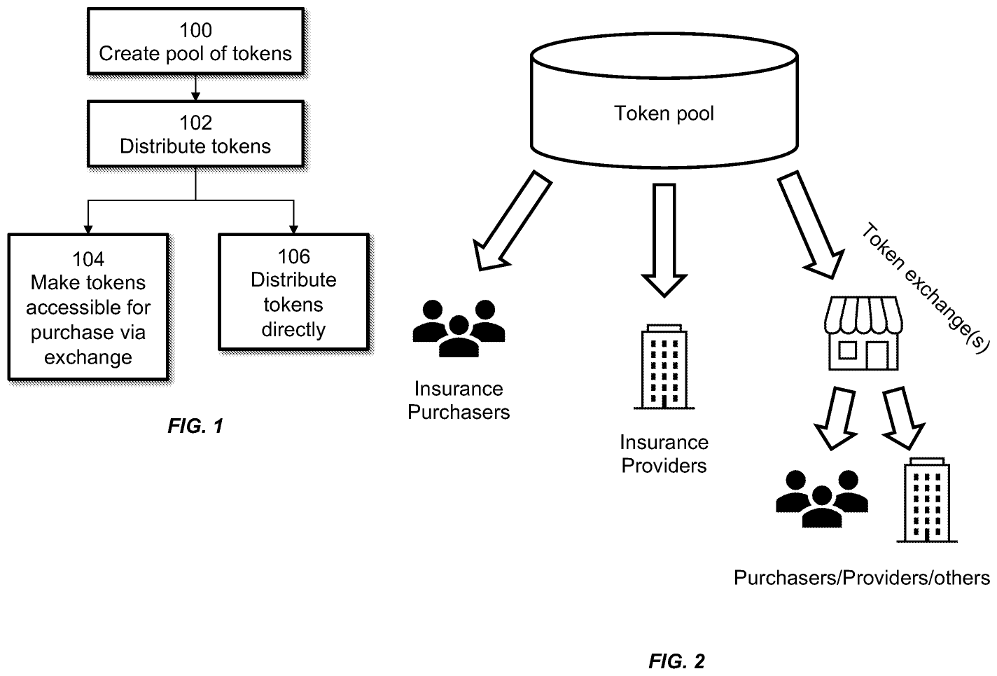

In embodiments using a newly minted token, that token must first be created. Thus, as shown in FIG. 1, a pool of tokens is created in step 100. A token pool can be controlled by marketplace managers (e.g., an entity in charge of managing the marketplace), or the token pool can be decentralized and subject to market forces (e.g., once tokens are created, they can be bought and sold and are not owned until such a time as they are subject to transactions described in this application). Step 100 can involve creating a new token on an existing blockchain. In some embodiments, a new blockchain can be created (e.g., by forking off an existing chain), where the new blockchain is custom designed for use in the context of a marketplace of the inventive subject matter. Some existing blockchains that can be used include Ethereum, IBM blockchain, Algorand, NEAR, and so on. Tokens can then be distributed according to step 102. Distribution can occur in a variety of ways. Tokens can be made available for direct purchase via, e.g., crypto currency exchange according to step 104. Tokens can also be directly distributed to marketplace participants according to step 106, e.g., by air drop, at the time of account creation (e.g., when an insurance purchaser or seller signs up to use the marketplace), or as rewards for participating in the marketplace.

FIG. 2 shows visually how step 102 can result in token distribution to different marketplace participants. Whether a user is an insurance purchaser or an insurance seller, at the time of account creation or at different times while using the marketplace, tokens can be distributed directly to those users. Tokens can also be made available for purchase via exchange (e.g., Coinbase, Crypto.com and the like). This allows not only insurance purchasers and providers to buy tokens at will, it can also allow individuals outside of the marketplace to purchase tokens. In some embodiments only marketplace participants are able to purchase tokens. An insurance seller or purchaser may choose to buy tokens in anticipation of token value increasing at a future time, which could allow, e.g., a purchaser to subsidize an insurance policy purchase at a better rate. Subsidized purchasing will be discussed in more detail below.

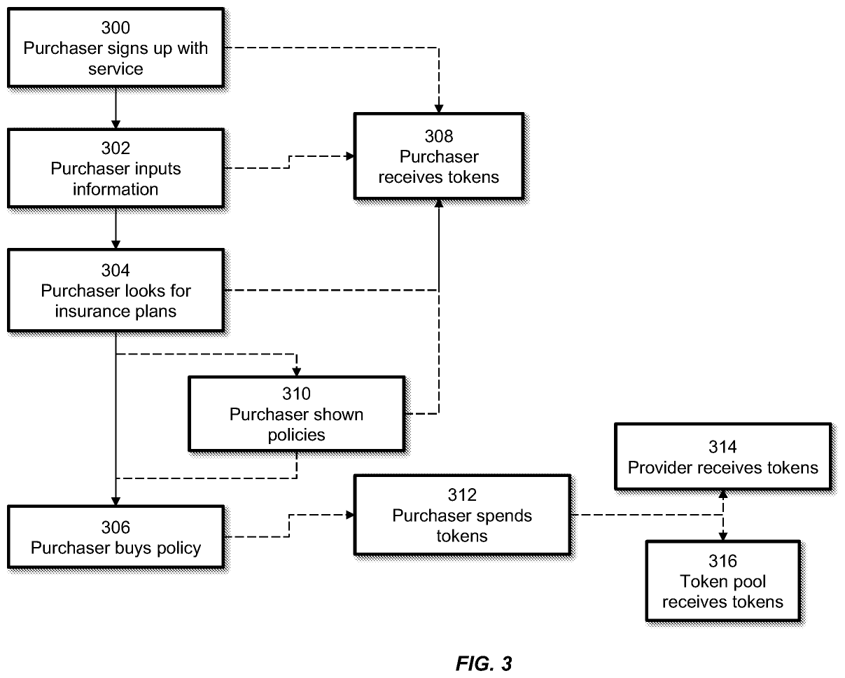

FIG. 3 is a flowchart describing how an insurance purchaser can interact with a marketplace of the inventive subject matter. In general, a purchaser signs up to use the server in step 300. When signing up, the purchaser creates an account that includes a wallet or prompts the user to grant access to an existing wallet that is capable of storing tokens of the inventive subject matter. Signing up can comprise creating an account.

In the course of signing up or at a time thereafter, per step 302, a purchaser can input information about themselves, their business, or their insurance needs. For example, business size, type of business (e.g., what the business does), number of employees, debts, liabilities, loss runs, audited or consolidated financial statements, other financial information, risk management protocols, safety protocols, general business information including ownership data, and historic coverages and premiums with commercial carriers, and so on, as applicable.

Once an account has been made, the purchaser can search for insurance plans according to step 304. Searching can take place by keyword or filtering. Policies can be filtered according to any parameters input by an insurance seller to describe their policies, such as policy limits, location, entity size, deductibles, co-pays, type of insurance, coverage limits, premiums, coverage types, available endorsements, swing rated plans, reinsurance providers, and so on. Finally, after looking for a policy, a purchaser can choose a policy to purchase and buy that policy, according to step 306.

Throughout this process, different actions can take place to incentivize participation by creating a token economy in addition to (or in place of) real money transactions. To create this token economy, tokens can be awarded to a purchaser before and throughout the policy purchasing process. All or any subset of the described token awards can occur while a purchaser uses the marketplace.

There are several circumstances that can result in a purchaser receiving tokens according to step 308. When a purchaser signs up to use the marketplace by creating an account according to step 300, they can receive tokens. When a purchaser inputs information according to step 302, they receive tokens. When a purchaser searches for insurance policies according to step 304, they can receive tokens. This list is not intended to be comprehensive.

In some situations, tokens are received by a purchaser in step 308 from the token pool, while in other situations tokens can be received by a purchaser from a provider, either directly or indirectly. By creating situations where tokens flow between purchasers and providers, a token economy can be created that incentivizes use of the marketplace in ways that maximize efficiency of the process of buying and selling insurance policies.

For example, when a purchaser signs up to use the marketplace, inputs information, or looks for an insurance, the purchaser can receive tokens from the token pool. But, in some embodiments, purchasers can additionally or alternatively receive tokens from insurance sellers in these instances. For example, if a purchaser inputs information about themselves (e.g., business size, number of employees, debts, and liabilities, etc.), the purchaser can receive tokens from a provider (e.g., directly or indirectly) in exchange for that information. Information about the purchaser can be useful for the provider to better tailor its insurance policies to real purchasers using the marketplace, thereby improving efficiency within the marketplace.

When a purchaser buys a policy, the purchaser can then spend tokens according to step 312. In addition to tokens, the purchaser can spend real money when buying a policy. When a purchaser uses tokens to buy a policy, those tokens can go to the provider in step 314, back to the token pool in step 316, or to both (e.g., by some split, or by sending tokens to the pool where they can then be distributed to the provider). While not necessary to spend tokens when buying a policy (e.g., tokens can be held indefinitely, if desired), tokens can be used to offset the price of a purchased policy. If a purchaser uses tokens to offset policy costs, those tokens can be awarded to the policy provider according to step 314, and the policy provider can then use those tokens to, e.g., gather information about other purchasers, advertise their policies to other purchasers, list new policies, etc.

During step 304, when a purchaser is searching for an insurance policy, the purchaser is shown insurance policies and can also be served advertisements for insurance policies according to step 310. As mentioned above, providers can spend tokens to serve such advertisements. When a policy is shown to purchasers as advertisements (and even via ordinary listing) can result in purchasers receiving tokens according to step 308. Purchasing advertisements can also result in tokens simply being returned to the token pool, or tokens being split between the token pool and the purchaser.

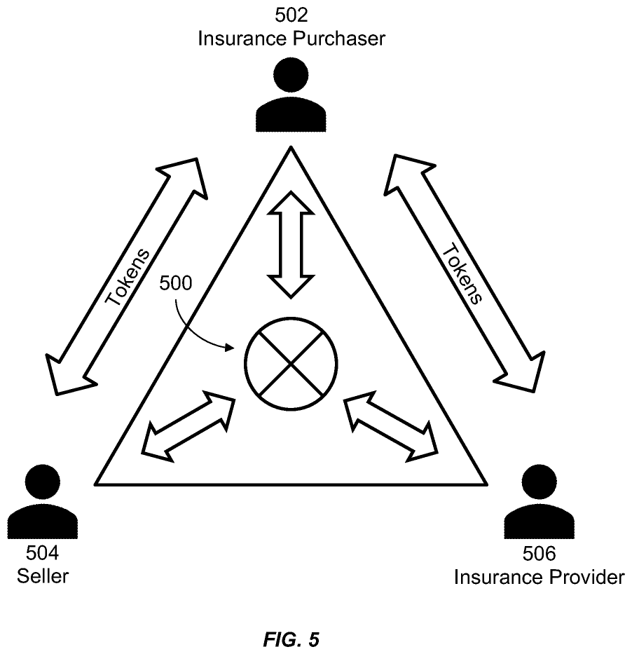

Because any individual instance of tokens being received by or sent from a purchaser can be omitted, each of these steps (308-316), is shown with a dotted line. A more detailed discussion of a token economy of the inventive subject matter is discussed in more detail below regarding FIG. 5. It should be understood that for purposes of creating a token economy, each purchaser and provider should be able spend and receive tokens for at least one type of activity.

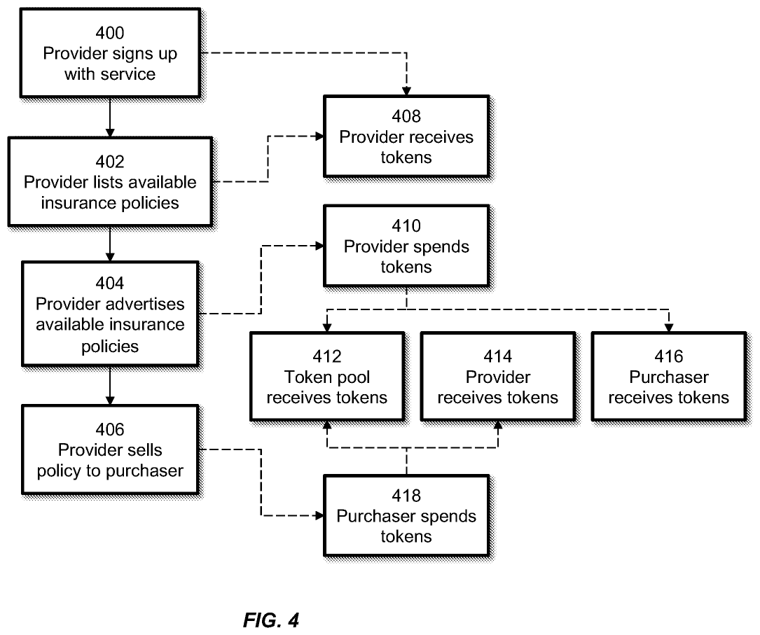

FIG. 4 is a flow chart describing how an insurance seller can interact with a marketplace of the inventive subject matter. In step 400, the provider signs up with the service. In doing so, the provider is either given a wallet for token storage, or the provider is asked to link an existing wallet capable of storing tokens of the inventive subject matter. In step 402, the provider inputs policy information, and as a result policies can be listed for sale within the marketplace. In some embodiments, insurance policy offerings having pre-determined parameters can be input, though it is also contemplated that insurance sellers can sell custom insurance policies. When custom policies are provided, providers can be prompted to input ranges that can be advertised to purchasers based on purchasers' needs, and then a purchaser can select the exact policy parameters.

In step 404, as mentioned above, a provider can advertise insurance policies. An advertisement can include a paid listing that is given preferential treatment, e.g., in searches. Finally, in step 406, the provider sells an insurance policy to a purchaser.

As with the flowchart in FIG. 3, FIG. 4 involves multiple steps where tokens can move between parties or be awarded. For example, when a provider signs up with the service to gain access to the marketplace per step 400, the provider can be awarded tokens per step 408. In step 402, when the provider lists available insurance policies that can be searched for and purchased by purchasers, the provider can be awarded tokens per step 408.

In step 404, where a provider advertises one or more available insurance policies, the provider can spend tokens according to step 410. Spending tokens to advertise policies can result in, e.g., preferential listing of those policies. In some embodiments, providers must spend tokens to list policies at all. When a provider spends tokens according to step 410, those tokens can end up in the token pool per step 412, with one or more purchasers per step 416 (e.g., a purchaser that is shown the advertised policy), or both. Finally, when a provider sells a policy to a purchaser according to step 406, a purchaser spends tokens according to step 418, and those tokens can end up in the token pool per step 412, with the insurance seller from step 414, or both.

FIG. 5 shows in more detail how token economies of the inventive subject matter can work. For purposes of explanation, three different roles are identified: seller, insurance provider, and insurance purchaser. An insurance provider can be any entity that provides insurance coverage and can also take on a role as a seller, and a seller can be any entity that sells insurance policies (e.g., an insurance provider, insurance advertiser, or a broker.) FIG. 5 graphically represents a marketplace 500 of the inventive subject matter that can connect purchaser 502 with insurance provider 506 and, in some embodiments, with seller 504. Although sellers can be brokers, marketplaces of the inventive subject matter do not require brokers and can facilitate direct purchasing of insurance policies.

As discussed above, purchaser 502 can connect to marketplace 500 to search for an insurance policy to purchase. In carrying out these actions, purchaser 502 can give information and spend tokens. Information the purchaser can give (e.g., to the platform server or to insurance sellers) includes policy requirements such as limits, deductibles, historic loss runs, historic premiums, risk management and safety protocols, financials statements, general business data, co-pays, and so on. In exchange for that information (and for participation in the marketplace, generally), purchasers can receive tokens (e.g., from the token pool or from insurance sellers, directly or indirectly). In searching for an insurance policy, purchaser 502 can receive information that helps to find better insurance rates such as premium, coverage limits, and comparison with other quotes and information that helps to manage risk more effectively such on guidance on how to respond to incidents, how to manage claims, or forecasting on which claims might progress to litigation. Once purchaser 502 has successfully identified an insurance policy to purchase, they can spend tokens to offset the policy's cost. Those tokens, as discussed above, can be given to insurance provider 506 that purchaser 502 purchases a policy from, can be given to the token pool, or both. Double-sided arrows indicating token exchange between purchasers, sellers, and providers should be understood to describe both direct exchange of tokens as well as exchange of tokens facilitated by a token pool (e.g., acting as an escrow) where tokens are sent first to a token pool and then to a final destination.

Insurance provider 506 participates in marketplace 500 similarly. Insurance provider 506 can receive tokens and payment from purchaser 502, and insurance provider 506 can giver insurance plan information, e.g., information relevant to managing and reducing risk and information relevant to managing litigation, such as risk management and safety protocols, historic loss runs, management biographical data and related materials, business plans, and details on vendors whose services reduce the aggregate cost of risk. In some embodiments, when insurance provider 506 provides insurance plan information, they receive tokens (e.g., from the token pool). And when insurance provider 506 receives tokens in selling a policy to, e.g., purchaser 502, those tokens can come either directly from purchaser 502 or from the token pool. When tokens area received from the token pool in connection with a sale, the number of tokens received can correlate with the amount of tokens spent by purchaser 502 such that, e.g., the token pool acts as an escrow.

In some cases, seller 504 is an optional role that an insurance seller can take on, while in some embodiments, seller 504 can be an insurance broker. Thus, a marketplace of the inventive subject matter can support providers as well as brokers, though neither is required for a marketplace to function. In one example, seller 504 is an insurance seller that interacts with marketplace 500 to advertise insurance policies it provides. Advertisements can be paid for with tokens, real money, or a combination of both. Seller 504 can receive information about purchasers and information about plans bought by purchasers in exchange for tokens, money, or both. Advertisements can be given preferential listing space (e.g., placed at the top of a search, etc.) and can be given preferential search parameters (e.g., an advertisement can be allowed to include more search keywords than normal listings). In another example, seller 504 is an insurance broker that interacts with marketplace 500 to advertise or sell insurance policies provided by insurance sellers. Advertisements by brokers can be paid for with tokens, real money, or a combination of both. A broker can receive information about purchasers and information about plans bought by purchasers in exchange for tokens, money, or both. Advertisements can be given preferential listing space (e.g., placed at the top of a search, etc.) and can be given preferential search parameters (e.g., an advertisement can be allowed to include more search keywords than normal listings). When a policy is sold by a broker, the broker can receive tokens according to that sale, and the insurance seller whose policy is ultimately purchased can also receive tokens according to that sale. Thus, when a policy is sold by a broker, tokens can pass from insurance purchaser to a broker, an insurance seller, or both.

As discussed above, any time tokens move between parties interacting on marketplace 500, those tokens can move directly between involved parties. In some embodiments, tokens can be transferred indirectly such that parties receive tokens from the token pool (or, e.g., some other third party) despite those tokens originating from another party.

It is also contemplated that tokens can move between parties according to smart contracts. Because tokens of the inventive subject matter exist on a blockchain, smart contracts can be implemented such that tokens automatically transfer between wallets upon certain conditions being met. For example, if purchaser 502 buys a policy from insurance provider 506, as soon as a contract is digitally signed to bring the policy into effect, a smart contract could receive confirmation of that signature and cause tokens to transfer from purchaser 502 to insurance provider 506. The same is true for, e.g., a sale through a broker. When a sale is executed through a broker, smart contracts can bring about token transfers according to that sale such that every party that is supposed to receive tokens receives them upon finalizing the sale.

Thus, specific systems and methods directed to marketplaces with incentivized participation have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

1. A method of creating an incentivized insurance policy marketplace, comprising:
creating a token pool on a blockchain;
configuring the insurance marketplace to facilitate transactions between an insurance provider and an insurance purchaser;
receiving, by the insurance purchaser via the marketplace, tokens from the token pool at least upon creating a purchaser account with the marketplace;
receiving, by the insurance provider, tokens from the token pool at least upon creating a provider account with the marketplace; and
spending, by the insurance purchaser, tokens to purchase an insurance policy from the insurance provider via the marketplace, wherein spent tokens offset a cost of the insurance policy, and wherein at least a portion of the spent tokens are received by the insurance provider.

2. The method of claim 1, further comprising the step of receiving, by the insurance purchaser, additional tokens for providing information, wherein the information comprises insurance policy requirements for the insurance purchaser.

3. The method of claim 1, further comprising the step of receiving, by the insurance provider, additional tokens for providing information, wherein the information comprises insurance policy parameters of insurance policies listed for sale on the marketplace.

4. The method of claim 1, further comprising the step of receiving, by the insurance purchaser via the marketplace, additional tokens upon conducting a search of the marketplace for available insurance policies.

5. The method of claim 1, further comprising the step of receiving, by the token pool, at least a second portion of the spent tokens.

6. The method of claim 1, further comprising the step of spending tokens, by the insurance provider, to advertise insurance policies.

7. A method of creating an incentivized insurance policy marketplace, comprising:
creating a token pool on a blockchain;
making the token pool available for purchase on a crypto exchange;
configuring the marketplace to facilitate transactions between an insurance provider and an insurance purchaser;
sending, to the insurance purchaser, tokens from the token pool at least upon creating a purchaser account with the marketplace;
sending, to the insurance provider, tokens from the token pool at least upon creating a provider account with the marketplace; and
facilitating transfer of tokens from the insurance purchaser to the insurance provider upon the insurance purchaser buying an insurance policy from the insurance provider via the marketplace, wherein spent tokens offset a cost of the insurance policy, and wherein at least a portion of the spent tokens are received by the insurance provider.

8. The method of claim 7, further comprising the step of sending, to the insurance purchaser, additional tokens for providing information, wherein the information comprises insurance policy requirements for the insurance purchaser.

9. The method of claim 7, further comprising the step of sending, to the insurance provider, additional tokens for providing information, wherein the information comprises insurance policy parameters of insurance policies listed for sale on the marketplace.

10. The method of claim 7, further comprising the step of sending, to the insurance purchaser, additional tokens upon conducting a search of the marketplace for available insurance policies.

11. The method of claim 7, further comprising the step of facilitating transfer, to the token pool, at least a second portion of the spent tokens.

12. The method of claim 7, further comprising the step of advertising insurance policies via the marketplace in exchange for tokens received from the insurance provider.
